(19) United States
(12) Patent Application Publication
(10) Pub. No.: US 2024/0183255 A1
(43) Pub. Date: Jun. 6, 2024

(54) TEMPERATURE PROFILE PREDICTION IN OIL AND GAS INDUSTRY UTILIZING MACHINE LEARNING MODEL

(71) Applicant: Saudi Arabian Oil Company, Dhahran (SA)

(72) Inventors: Ahmed Alqahtani, Al Hofuf (SA); Khaled Alsunnary, Dammam (SA); Abiola Onikoyi, Udhailiyah (SA); Obiomalotaoso Leonard Isichei, Dhahran (SA); Bayan Almomtan, Dammam (SA)

(21) Appl. No.: 18/075,880

(22) Filed: Dec. 6, 2022

(51) Int. Cl. E21B 43/16

(52) U.S. Cl. CPC E21B 43/16; E21B 2200/22

(57) ABSTRACT

Systems and methods include a computer-implemented method for predicting temperatures. Temperature data corresponding to historical drilling operations of a well is collected and stored in a database. The database is split into a training dataset and an evaluation dataset. Space-time-temperature probability models are generated using the training dataset. The space-time-temperature probability models are trained using the evaluation dataset. The space-time-temperature probability models are evaluated to ensure a performance level above a model accuracy threshold. A predicted temperature profile for a new well is generated using the space-time-temperature probability models.

### TECHNICAL FIELD

The present disclosure applies to temperature profiles in wells, e.g., in the gas and oil industry.

### BACKGROUND

The current practice in the gas and oil industry is to conduct a temperature survey for a well (e.g., see FIG. 1), and then receive the data for the well. Then the data is analyzed trying to manually identify valid points and invalid points. This process is repeated for every survey.

### SUMMARY

The present disclosure describes techniques that can be used for predicting a temperature profile for a new well by using machine learning. In some implementations, a computer-implemented method includes the following. Temperature data corresponding to historical drilling operations of a well is collected and stored in a database. The database is split into a training dataset and an evaluation dataset. Space-time-temperature probability models are generated using the training dataset. The space-time-temperature probability models are trained using the evaluation dataset. The space-time-temperature probability models are evaluated to ensure a performance level above a model accuracy threshold. A predicted temperature profile for a new well is generated using the space-time-temperature probability models.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. The techniques of the present disclosure can provide solutions to solve temperature-related technical problems by developing a machine learning program that can improve predictive temperature profiles, provide better indications regarding potential leaks, and reduce the number of temperature surveys needed. Analysis of historical data can be used to predict temperature profiles in oil, water, or gas wells utilizing machine learning models. Compiled and quality-checked data from historical temperature surveys can be used in model training and testing. Multiple iterations using test and training data with a machine learning model can improve model accuracy.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a flow diagram of an example of a workflow for using a probabilistic meta model to combine output from two models, according to some implementations of the present disclosure.

FIG. 2 is a graph showing examples of plotted historical temperature surveys of one well against depth, according to some implementations of the present disclosure.

FIG. 3 is a flow diagram showing an example of a modeling process workflow, according to some implementations of the present disclosure.

FIG. 4 is a flow diagram showing an example of a workflow for a time series forecasting model, according to some implementations of the present disclosure.

FIG. 5 is a flow diagram showing an example of a workflow for scoring a time series forecasting model to predict a future temperature survey, according to some implementations of the present disclosure.

FIG. 6 is a flow diagram showing an example of a Kriging model training workflow, according to some implementations of the present disclosure.

FIG. 7 is a flow diagram showing an example of a Kriging model scoring workflow for predicting a temperature survey for an un-surveyed well, according to some implementations of the present disclosure.

FIG. 8 is a flow diagram showing an example of a workflow for determining a probabilistic meta model structure, according to some implementations of the present disclosure.

FIG. 9 is a flowchart of an example of a method for predicting a temperature profile for a new well by using space-time-temperature probability models and machine learning, according to some implementations of the present disclosure.

FIG. 10 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for predicting a temperature profile for a new well by using machine learning. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The innovation describes a new approach to create a temperature profile in oil, water, or gas wells utilizing a machine learning model. The concept is to generate a temperature pattern using a time series forecasting model based on the historical temperature surveys and a spatial correlation model based on temperature spatial patterns. The solution can utilize a probabilistic model to combine predictions from the spatial correlation model and the time series forecasting model in order to predict the next temperature survey profile.

Techniques of the present disclosure can be used to aggregate stored survey data/information and patterns from thousands of temperature surveys in a database to develop a software program for creating a predictive model that can be trained. Once the predictive model is trained, the model can predict future temperature profiles based on the huge cache of information. Probabilistic combinations of multiple underlying models can be performed, including using models for the spatial distribution of temperature trends of offset wells and models used in forecasting temperature trends based on historical readings collected from the same well.

Leaks are a result of corrosion that occurs overtime over the lifetime of the well. Historical trends of changing temperatures inside the wellbore can provide an indication of future risks of leaks. In addition, corrosion trends that ultimately lead to leaks may be caused by spatially distributed environmental factors such as surrounding formation lithology, formation fluid distribution, and pressure-volume-temperature (PVT) properties. These properties are typically not measured vigilantly, but rather by spatial correlation. A goal of using the techniques of the present disclosure is to capture these patterns from multiple sources, in order to predict the temperature survey for a well.

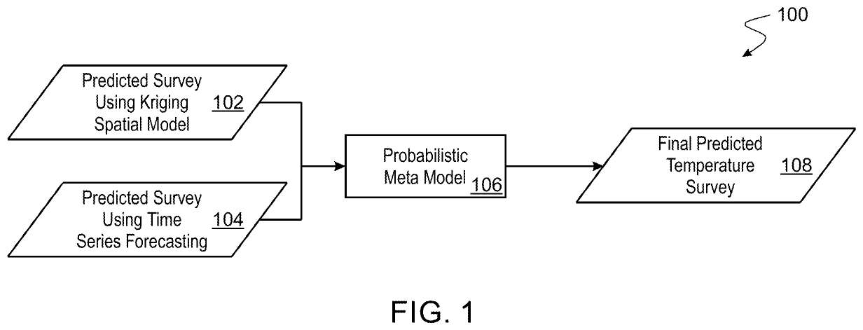

FIG. 1 is a flow diagram of an example of a workflow 100 for using a probabilistic meta model to combine output from two models, according to some implementations of the present disclosure. For example, a probabilistic meta model 106 can combine predicted surveys from a Kriging spatial model 102 and time series forecasting model 104 to generate a final predicted temperature survey 108 for an un-surveyed well.

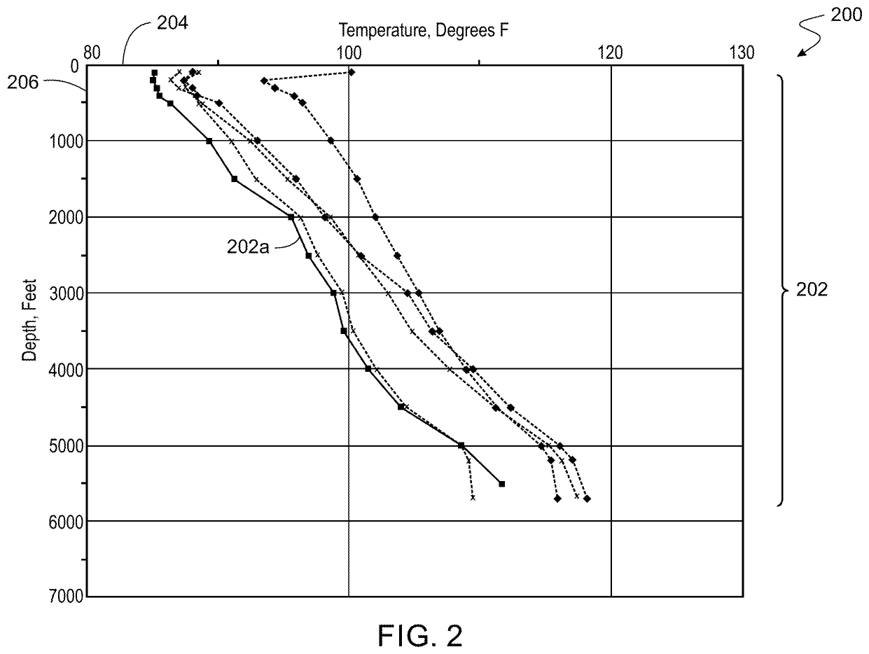

The workflow 100 provides the benefits of providing predictive temperature profiles and for reducing the number of temperature surveys needed. An example of the temperature survey and detailed implementation of this idea is provided in FIG. 2.

FIG. 2 is a graph 200 showing examples of plotted historical temperature surveys 202 of one well against depth, according to some implementations of the present disclosure. The temperature surveys 202, including most recent survey 202a, are plotted relative to a temperature axis 204 (e.g., in Fahrenheit) and a depth axis 206 (e.g., in feet).

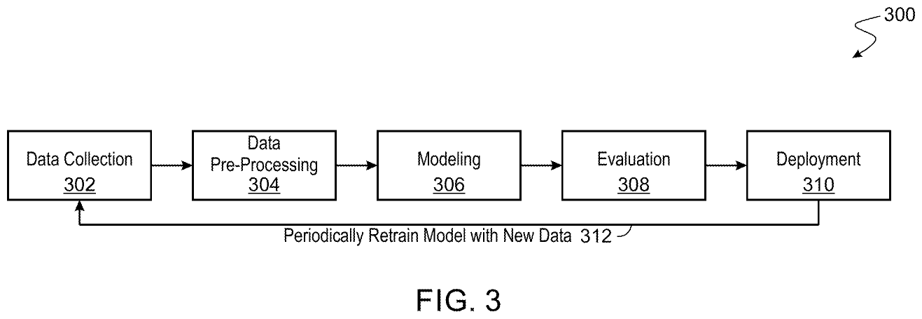

FIG. 3 is a flow diagram showing an example of a modeling process workflow 300, according to some implementations of the present disclosure. At 302, data collection occurs in which data is collected from various database sources. At 304, data pre-processing occurs in which all data needed for modeling is compiled into a dataset. The data pre-processing includes cleaning temperature log historical data regarding its validity. Also, in this step, the dataset is split into training and evaluation datasets.

At 306, modeling occurs. A kriging spatial model can be developed for each depth layer. The kriging spatial model can interpolate temperature values for a given location and depth based on measured values in offset wells. A time series forecasting model (e.g., multivariate long short-term memory (LSTM)) can be developed using multiple time series datasets, one for each well. A loop can be used to train LSTM model weights based on the multiple datasets. A probabilistic meta model can be developed for generating a resulting predicted survey using kriging spatial correlation and time series models. Weights can be assigned to each input survey. In some cases, the weights can be learned during a training process and then validated.

At 308, evaluation occurs in which models are evaluated using a test dataset to ensure a satisfactory level of performance before deployment 310. At 312, models can be periodically retrained in this step. The training process can be repeated based on triggers such as a regular schedule, when new surveys are collected, or when it is determined that model accuracy threshold is not reached or a new threshold is to be established.

In some implementations, a final prediction can be based on the use of three sub-models, as described in the following sections:

### Time Series Forecasting

Time series forecasting model can use historical temperature surveys from the same well to predict future temperature surveys. The time series forecasting model will not be trained for one well data since one well has only a limited number of historical surveys. As such, the same forecasting model can be trained using multiple sub-datasets from all training wells. The training can be based on a target, such as a vector temp survey. The training can also use features and parameters from a dataset of full survey vectors that are identified by timestamp (e.g., a 07-01-2001 survey, a 07-01-2002 survey, and so on). The training can also be based on assumptions, e.g., there is autocorrelation in temperature trends, and the temperature dataset has stationarity. Each target point at a depth d₁ can be influenced by previous measurements at other depths (d₂, d₃, . . . dₖ).

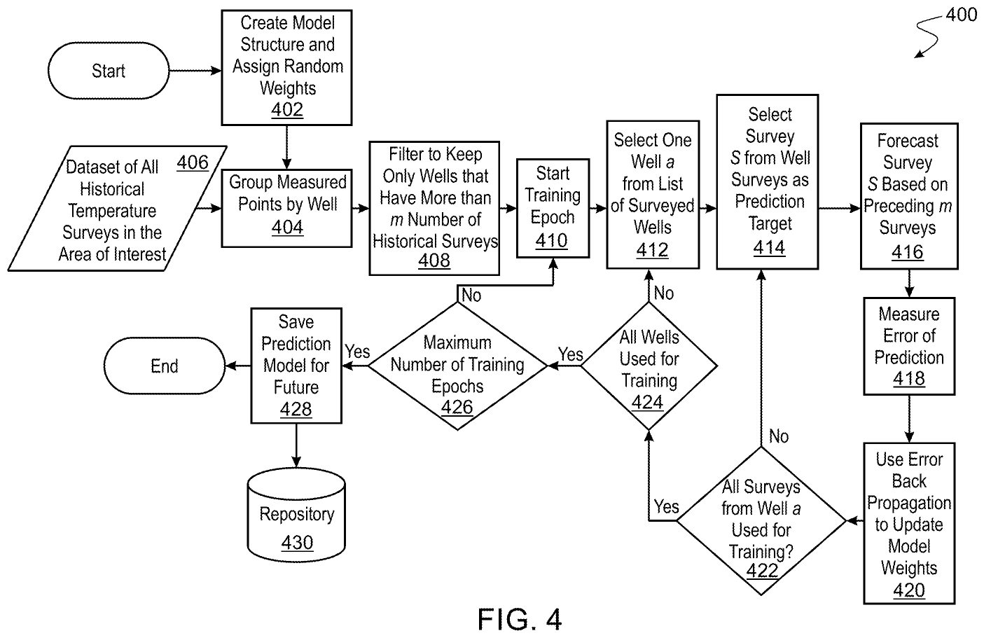

FIG. 4 is a flow diagram showing an example of a workflow 400 for a time series forecasting model, according to some implementations of the present disclosure. At 402, a model structure is created, and random weights are assigned to parameters of the model. At 404, measured points are grouped by well using a dataset 406 of all historical temperature surveys in an area of interest. At 408, filtering occurs to keep only wells that have more than M number of historical surveys. At 410, a training epoch is started. At 412, one well A is selected from a list of surveyed wells. At 414, a survey S is selected from the surveys as a prediction target. At 416, the survey S is forecast based on the preceding m surveys. At 418, an error of prediction is measured. Otherwise, at 420, error back prosecution is used to update model weights. At 422, a determination is made whether all surveys from well A have been used for training. If not, then processing continues at 414. If so, at 424, a determination is made whether all wells have been used for training. If not, then processing continues at 412. Otherwise, at 426 a determination is made whether a maximum number of training epochs have been used. If not, then processing continues at 410. Otherwise, at 428, the prediction model is saved and stored in a repository 430.

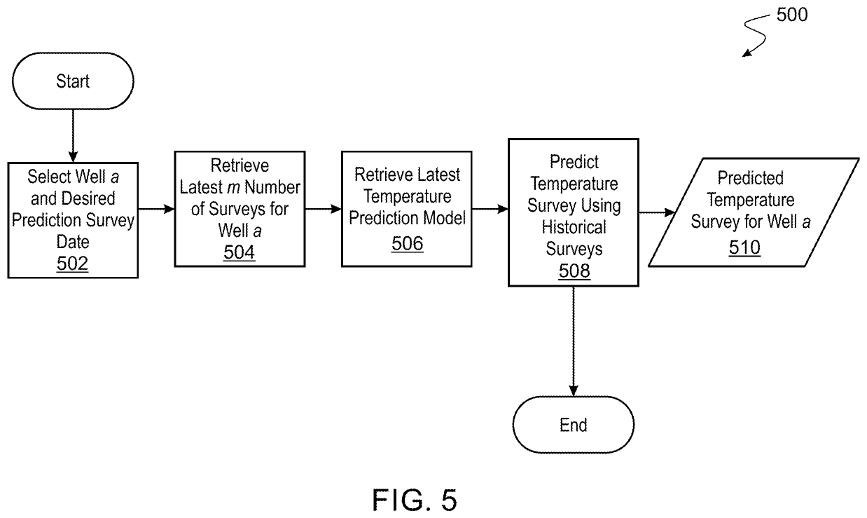

FIG. 5 is a flow diagram showing an example of a workflow 500 for scoring a time series forecasting model to predict a future temperature survey, according to some implementations of the present disclosure. At 502, a Well A and its desired prediction survey data are selected. At 504, the latest M number of surveys are retrieved for Well A. At 506, the latest temperature and prediction model is retrieved. At 508, a temperature survey is predicted using historical surveys in order to generate a predicted temperature survey 510 for well A.

### Kriging Spatial Model

The Kriging spatial model can use spatial weighted interpolation to predict temperature survey in a well location based on data collected from offset wells. Inputs to the model include the latest measurements of offset wells at a depth d₁. Outputs of the model include a map of kriging predicted values for (x,y) locations grid at same depth d₁. Assumptions used by the model include assumptions that each temperature point at a depth d₁ is independent from temperature values at different depths (d₂, d₃, . . . dₖ). In this way, there is a spatial correlation between temperature measurements.

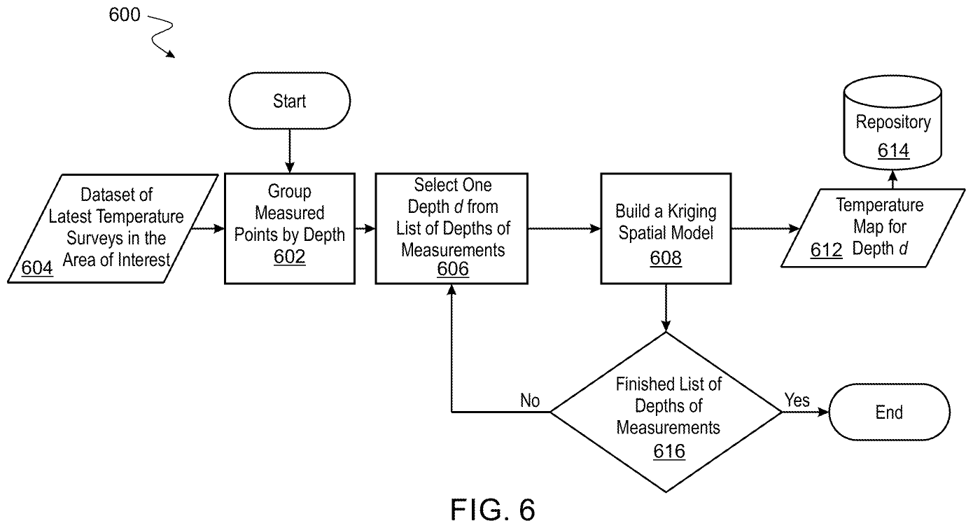

FIG. 6 is a flow diagram showing an example of a Kriging model training workflow 600, according to some implementations of the present disclosure. At 602, measured points are grouped by depth using a dataset 604 of the latest temperature surveys in an area of interest. At 606, a single depth d is selected from a list of depths of measurements. At 608, a kriging spatial model is built for all the temperature readings from different locations at depth d, generating a temperature map 612 for the depth d, which is stored in a repository 614. At 616, a determination is made whether additional depths are to be processed. If not, then the method 600 resumes at step 606. Otherwise, the method 600 can terminate.

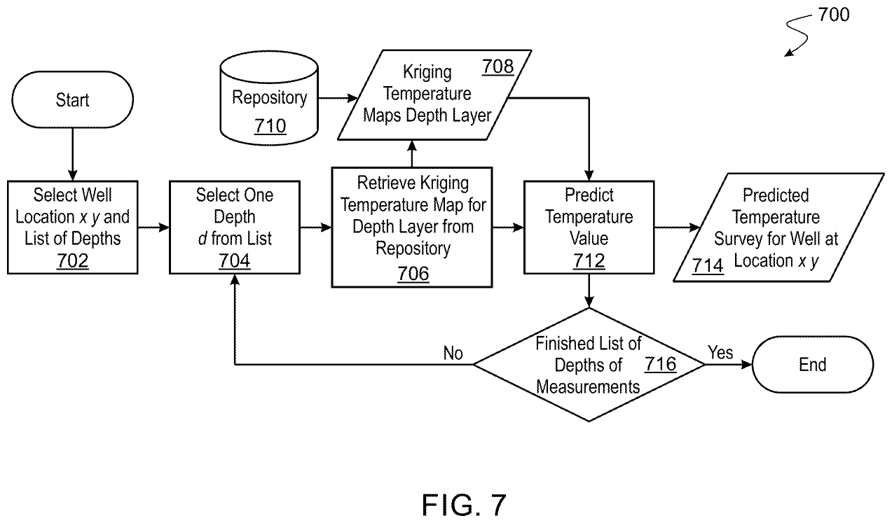

FIG. 7 is a flow diagram showing an example of a Kriging model scoring workflow 700 for predicting a temperature survey for an un-surveyed well, according to some implementations of the present disclosure. At 702, a well location x,y and a list of depths are selected. At 704, a depth d is selected from a list of depths. At 706, a kriging temperature map 708 is retrieved for the depth layer from a repository 710. At 712, a temperature value is predicted to generate a predicted temperature survey 714 for the well at locations x and y. At 716, a determination is made whether measurements are complete for the list of depths. If not, then processing for the method 700 can resume at step 704. Otherwise, the method 700 can end.

### Probabilistic Meta Model

The probabilistic meta model is an over-layer that combines the two predicted surveys using the aforementioned models to make a final predicted survey that captures both the spatial patterns and well historical patterns. Each input survey has a weight that is learned during a training process and then validated.

### Final Predicted Surveys

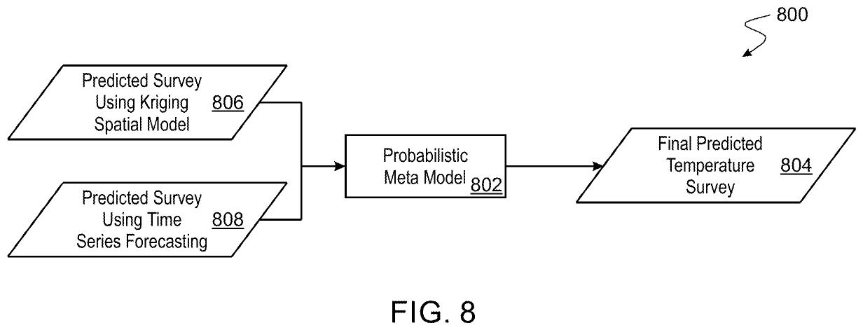

FIG. 8 is a flow diagram showing an example of a workflow 800 for determining a probabilistic meta model structure, according to some implementations of the present disclosure. At 802, a probabilistic meta model 808 generates a final predicted temperature survey 804 using a predicted survey 806 using a Kriging spatial model and a predicted survey 808 using time series forecasting.

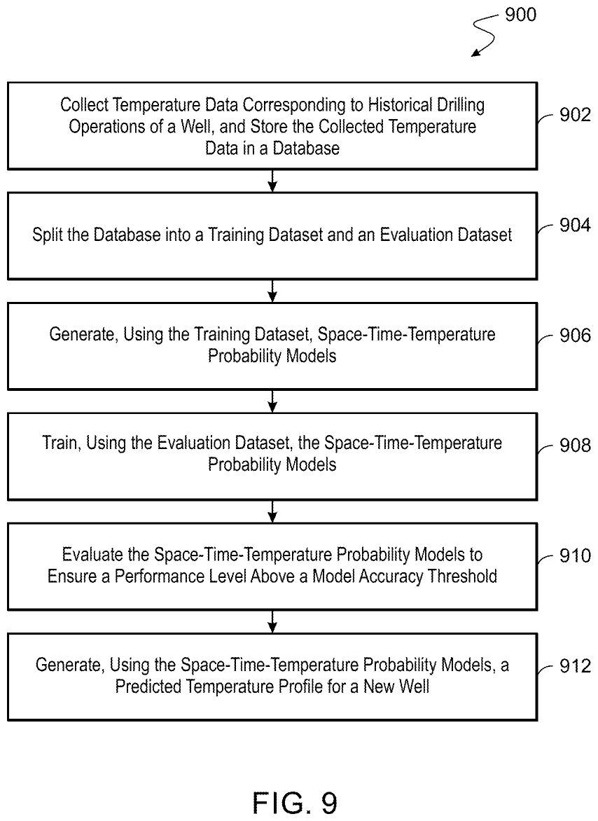

FIG. 9 is a flowchart of an example of a method 900 for predicting a temperature profile for a new well by using space-time-temperature probability models and machine learning, according to some implementations of the present disclosure. For clarity of presentation, the description that follows generally describes method 900 in the context of the other figures in this description. However, it will be understood that method 900 can be performed, for example, by any suitable system, environment, software, and hardware, or a combination of systems, environments, software, and hardware, as appropriate. In some implementations, various steps of method 900 can be run in parallel, in combination, in loops, or in any order.

At 902, temperature data corresponding to historical drilling operations of a well is collected and stored in a database. From 902, method 900 proceeds to 904.

At 904, the database is split into a training dataset and an evaluation dataset. In some implementations, the temperature data in the database can be cleaned for validity before splitting the database into the training dataset and the evaluation dataset. From 904, method 900 proceeds to 906.

At 906, space-time-temperature probability models are generated using the training dataset. For example, the space-time-temperature probability models can include a kriging spatial model, a time series forecasting model, and a probabilistic meta model. The models can be configured to be integrated such that the models can be executed in a coordinated and automatic fashion. This can include data sharing by the models and sending information between the models such as in the form of outputs and inputs. From 906, method 900 proceeds to 908.

At 908, the space-time-temperature probability models are trained using the evaluation dataset. From 908, method 900 proceeds to 910.

At 910, the space-time-temperature probability models are evaluated to ensure a performance level above a model accuracy threshold. From 910, method 900 proceeds to 912.

In some implementations, method 900 further includes re-training of the space-time-temperature probability models. For example,

Re-training of the space-time-temperature probability models can be triggered based on triggering criteria, and the space-time-temperature probability models can be re-trained over time. The triggering criteria can include one or more of a regular retraining schedule, an occurrence of collecting new oil/gas surveys, and changes in the model accuracy threshold.

At 912, a predicted temperature profile for a new well is generated using the space-time-temperature probability models. For example, method 900 can further include generating, for display in a user interface, a plot of the predicted temperature profile for the new well. For example, a plot prepared for a user (e.g., petroleum engineer) can include features of the plot in FIG. 2. After 912, method 900 can stop.

In some implementations, in addition to (or in combination with) any previously-described features, techniques of the present disclosure can include the following. Outputs of the techniques of the present disclosure can be performed before, during, or in combination with wellbore operations, such as to provide inputs to change the settings or parameters of equipment used for drilling. Examples of wellbore operations include forming/drilling a wellbore, hydraulic fracturing, and producing through the wellbore, to name a few. The wellbore operations can be triggered or controlled, for example, by outputs of the methods of the present disclosure. In some implementations, customized user interfaces can present intermediate or final results of the above described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, drilling parameters (including drill bit speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

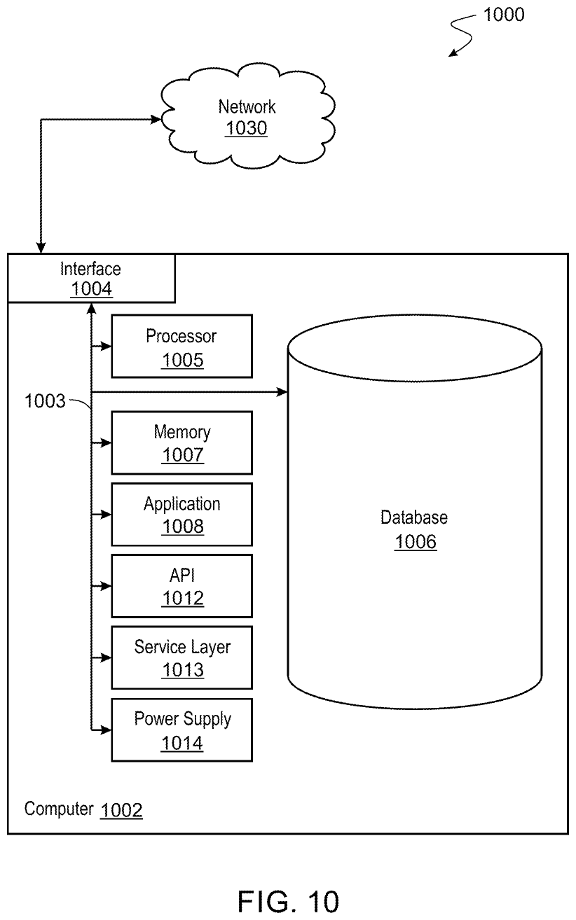

FIG. 10 is a block diagram of an example computer system 1000 used to provide computational functionalities associated with described algorithms, methods, functions, processes, flows, and procedures described in the present disclosure, according to some implementations of the present disclosure. The illustrated computer 1002 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1002 can include input devices such as keypads, keyboards, and touch screens that can accept user information. Also, the computer 1002 can include output devices that can convey information associated with the operation of the computer 1002. The information can include digital data, visual data, audio information, or a combination of information. The information can be presented in a graphical user interface (UI) (or GUI).

The computer 1002 can serve in a role as a client, a network component, a server, a database, a persistency, or components of a computer system for performing the subject matter described in the present disclosure. The illustrated computer 1002 is communicably coupled with a network 1030. In some implementations, one or more components of the computer 1002 can be configured to operate within different environments, including cloud-computing-based environments, local environments, global environments, and combinations of environments.

At a top level, the computer 1002 is an electronic computing device operable to receive, transmit, process, store, and manage data and information associated with the described subject matter. According to some implementations, the computer 1002 can also include, or be communicably coupled with, an application server, an email server, a web server, a caching server, a streaming data server, or a combination of servers.

The computer 1002 can receive requests over network 1030 from a client application (for example, executing on another computer 1002). The computer 1002 can respond to the received requests by processing the received requests using software applications. Requests can also be sent to the computer 1002 from internal users (for example, from a command console), external (or third) parties, automated applications, entities, individuals, systems, and computers.

Each of the components of the computer 1002 can communicate using a system bus 1003. In some implementations, any or all of the components of the computer 1002, including hardware or software components, can interface with each other or the interface 1004 (or a combination of both) over the system bus 1003. Interfaces can use an application programming interface (API) 1012, a service layer 1013, or a combination of the API 1012 and service layer 1013. The API 1012 can include specifications for routines, data structures, and object classes. The API 1012 can be either computer-language independent or dependent. The API 1012 can refer to a complete interface, a single function, or a set of APIs.

The service layer 1013 can provide software services to the computer 1002 and other components (whether illustrated or not) that are communicably coupled to the computer 1002. The functionality of the computer 1002 can be accessible for all service consumers using this service layer. Software services, such as those provided by the service layer 1013, can provide reusable, defined functionalities through a defined interface. For example, the interface can be software written in JAVA, C++, or a language providing data in extensible markup language (XML) format. While illustrated as an integrated component of the computer 1002, in alternative implementations, the API 1012 or the service layer 1013 can be stand-alone components in relation to other components of the computer 1002 and other components communicably coupled to the computer 1002. Moreover, any or all parts of the API 1012 or the service layer 1013 can be implemented as child or sub-modules of another software module, enterprise application, or hardware module without departing from the scope of the present disclosure.

The computer 1002 includes an interface 1004. Although illustrated as a single interface 1004 in FIG. 10, two or more interfaces 1004 can be used according to particular needs, desires, or particular implementations of the computer 1002 and the described functionality. The interface 1004 can be used by the computer 1002 for communicating with other systems that are connected to the network 1030 (whether illustrated or not) in a distributed environment. Generally, the interface 1004 can include, or be implemented using, logic encoded in software or hardware (or a combination of software and hardware) operable to communicate with the network 1030. More specifically, the interface 1004 can include software supporting one or more communication protocols associated with communications. As such, the network 1030 or the interface's hardware can be operable to communicate physical signals within and outside of the illustrated computer 1002.

The computer 1002 includes a processor 1005. Although illustrated as a single processor 1005 in FIG. 10, two or more processors 1005 can be used according to particular needs, desires, or particular implementations of the computer 1002 and the described functionality. Generally, the processor 1005 can execute instructions and can manipulate data to perform the operations of the computer 1002, including operations using algorithms, methods, functions, processes, flows, and procedures as described in the present disclosure.

The computer 1002 also includes a database 1006 that can hold data for the computer 1002 and other components connected to the network 1030 (whether illustrated or not). For example, database 1006 can be an in-memory, conventional, or a database storing data consistent with the present disclosure. In some implementations, database 1006 can be a combination of two or more different database types (for example, hybrid in-memory and conventional databases) according to particular needs, desires, or particular implementations of the computer 1002 and the described functionality. Although illustrated as a single database 1006 in FIG. 10, two or more databases (of the same, different, or a combination of types) can be used according to particular needs, desires, or particular implementations of the computer 1002 and the described functionality. While database 1006 is illustrated as an internal component of the computer 1002, in alternative implementations, database 1006 can be external to the computer 1002.

The computer 1002 also includes a memory 1007 that can hold data for the computer 1002 or a combination of components connected to the network 1030 (whether illustrated or not). Memory 1007 can store any data consistent with the present disclosure. In some implementations, memory 1007 can be a combination of two or more different types of memory (for example, a combination of semiconductor and magnetic storage) according to particular needs, desires, or particular implementations of the computer 1002 and the described functionality. Although illustrated as a single memory 1007 in FIG. 10, two or more memories 1007 (of the same, different, or combination of types) can be used according to particular needs, desires, or particular implementations of the computer 1002 and the described functionality. While memory 1007 is illustrated as an internal component of the computer 1002, in alternative implementations, memory 1007 can be external to the computer 1002.

The application 1008 can be an algorithmic software engine providing functionality according to particular needs, desires, or particular implementations of the computer 1002 and the described functionality. For example, application 1008 can serve as one or more components, modules, or applications. Further, although illustrated as a single application 1008, the application 1008 can be implemented as multiple applications 1008 on the computer 1002. In addition, although illustrated as internal to the computer 1002, in alternative implementations, the application 1008 can be external to the computer 1002.

The computer 1002 can also include a power supply 1014. The power supply 1014 can include a rechargeable or non-rechargeable battery that can be configured to be either user- or non-user-replaceable. In some implementations, the power supply 1014 can include power-conversion and management circuits, including recharging, standby, and power management functionalities. In some implementations, the power supply 1014 can include a power plug to allow the computer 1002 to be plugged into a wall socket or a power source to, for example, power the computer 1002 or recharge a rechargeable battery.

There can be any number of computers 1002 associated with, or external to, a computer system containing computer 1002, with each computer 1002 communicating over network 1030. Further, the terms “client,” “user,” and other appropriate terminology can be used interchangeably, as appropriate, without departing from the scope of the present disclosure. Moreover, the present disclosure contemplates that many users can use one computer 1002 and one user can use multiple computers 1002.

Described implementations of the subject matter can include one or more features, alone or in combination.

For example, in a first implementation, a computer-implemented method includes the following. Temperature data corresponding to historical drilling operations of a well is collected and stored in a database. The database is split into a training dataset and an evaluation dataset. Space-time-temperature probability models are generated using the training dataset. The space-time-temperature probability models are trained using the evaluation dataset. The space-time-temperature probability models are evaluated to ensure a performance level above a model accuracy threshold. A predicted temperature profile for a new well is generated using the space-time-temperature probability models.

The foregoing and other described implementations can each, optionally, include one or more of the following features:

A first feature, combinable with any of the following features, where the method further includes generating, for display in a user interface, a plot of the predicted temperature profile for the new well.

A second feature, combinable with any of the previous or following features, where the space-time-temperature probability models include a kriging spatial model, a time series forecasting model, and a probabilistic meta model.

A third feature, combinable with any of the previous or following features, where the method further includes cleaning the temperature data for validity before splitting the database into the training dataset and the evaluation dataset.

A fourth feature, combinable with any of the previous or following features, where the method further includes: triggering, based on triggering criteria, re-training of the space-time-temperature probability models; and re-training the space-time-temperature probability models over time

A fifth feature, combinable with any of the previous or following features, where the triggering criteria includes one or more of a regular retraining schedule, an occurrence of collecting new oil/gas surveys, and changes in the model accuracy threshold.

A sixth feature, combinable with any of the previous or following features, where the method further includes cleaning the temperature data in the database for validity before splitting the database into the training dataset and the evaluation dataset.

In a second implementation, a non-transitory, computer-readable medium stores one or more instructions executable by a computer system to perform operations including the following. Temperature data corresponding to historical drilling operations of a well is collected and stored in a database. The database is split into a training dataset and an evaluation dataset. Space-time-temperature probability models are generated using the training dataset. The space-time-temperature probability models are trained using the evaluation dataset. The space-time-temperature probability models are evaluated to ensure a performance level above a model accuracy threshold. A predicted temperature profile for a new well is generated using the space-time-temperature probability models.

The foregoing and other described implementations can each, optionally, include one or more of the following features:

A first feature, combinable with any of the following features, where the operations further include generating, for display in a user interface, a plot of the predicted temperature profile for the new well.

A second feature, combinable with any of the previous or following features, where the space-time-temperature probability models include a kriging spatial model, a time series forecasting model, and a probabilistic meta model.

A third feature, combinable with any of the previous or following features, where the operations further include cleaning the temperature data for validity before splitting the database into the training dataset and the evaluation dataset.

A fourth feature, combinable with any of the previous or following features, where the operations further include: triggering, based on triggering criteria, re-training of the space-time-temperature probability models; and re-training the space-time-temperature probability models over time

A fifth feature, combinable with any of the previous or following features, where the triggering criteria includes one or more of a regular retraining schedule, an occurrence of collecting new oil/gas surveys, and changes in the model accuracy threshold.

A sixth feature, combinable with any of the previous or following features, where the operations further include cleaning the temperature data in the database for validity before splitting the database into the training dataset and the evaluation dataset.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Temperature data corresponding to historical drilling operations of a well is collected and stored in a database. The database is split into a training dataset and an evaluation dataset. Space-time-temperature probability models are generated using the training dataset. The space-time-temperature probability models are trained using the evaluation dataset. The space-time-temperature probability models are evaluated to ensure a performance level above a model accuracy threshold. A predicted temperature profile for a new well is generated using the space-time-temperature probability models.

The foregoing and other described implementations can each, optionally, include one or more of the following features:

A first feature, combinable with any of the following features, where the operations further include generating, for display in a user interface, a plot of the predicted temperature profile for the new well.

A second feature, combinable with any of the previous or following features, where the space-time-temperature probability models include a kriging spatial model, a time series forecasting model, and a probabilistic meta model.

A third feature, combinable with any of the previous or following features, where the operations further include cleaning the temperature data for validity before splitting the database into the training dataset and the evaluation dataset.

A fourth feature, combinable with any of the previous or following features, where the operations further include: triggering, based on triggering criteria, re-training of the space-time-temperature probability models; and re-training the space-time-temperature probability models over time

A fifth feature, combinable with any of the previous or following features, where the triggering criteria includes one or more of a regular retraining schedule, an occurrence of collecting new oil/gas surveys, and changes in the model accuracy threshold.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
collecting temperature data corresponding to historical drilling operations of a well, and storing the collected temperature data in a database;
splitting the database into a training dataset and an evaluation dataset;
generating, using the training dataset, space-time-temperature probability models;
training, using the evaluation dataset, the space-time-temperature probability models;
evaluating the space-time-temperature probability models to ensure a performance level above a model accuracy threshold; and
generating, using the space-time-temperature probability models, a predicted temperature profile for a new well.

2. The computer-implemented method of claim 1, further comprising:
generating, for display in a user interface, a plot of the predicted temperature profile for the new well

3. The computer-implemented method of claim 1, wherein the space-time-temperature probability models include a kriging spatial model, a time series forecasting model, and a probabilistic meta model.

4. The computer-implemented method of claim 1, further comprising:
cleaning the temperature data for validity before splitting the database into the training dataset and the evaluation dataset.

5. The computer-implemented method of claim 1, further comprising:
triggering, based on triggering criteria, re-training of the space-time-temperature probability models; and
re-training the space-time-temperature probability models over time.

6. The computer-implemented method of claim 5, wherein the triggering criteria includes one or more of a regular retraining schedule, an occurrence of collecting new oil/gas surveys, and changes in the model accuracy threshold.

7. The computer-implemented method of claim 1, further comprising:
cleaning the temperature data in the database for validity before splitting the database into the training dataset and the evaluation dataset.

8. A non-transitory, computer-readable medium storing one or more instructions executable by a computer system to perform operations comprising:
collecting temperature data corresponding to historical drilling operations of a well, and storing the collected temperature data in a database;
splitting the database into a training dataset and an evaluation dataset;
generating, using the training dataset, space-time-temperature probability models;
training, using the evaluation dataset, the space-time-temperature probability models;
evaluating the space-time-temperature probability models to ensure a performance level above a model accuracy threshold; and
generating, using the space-time-temperature probability models, a predicted temperature profile for a new well.

9. The non-transitory, computer-readable medium of claim 8, the operations further comprising:
generating, for display in a user interface, a plot of the predicted temperature profile for the new well

10. The non-transitory, computer-readable medium of claim 8, wherein the space-time-temperature probability models include a kriging spatial model, a time series forecasting model, and a probabilistic meta model.

11. The non-transitory, computer-readable medium of claim 8, the operations further comprising:
cleaning the temperature data for validity before splitting the database into the training dataset and the evaluation dataset.

12. The non-transitory, computer-readable medium of claim 8, the operations further comprising:
triggering, based on triggering criteria, re-training of the space-time-temperature probability models; and
re-training the space-time-temperature probability models over time.

13. The non-transitory, computer-readable medium of claim 12, wherein the triggering criteria includes one or more of a regular retraining schedule, an occurrence of collecting new oil/gas surveys, and changes in the model accuracy threshold.

14. The non-transitory, computer-readable medium of claim 8, the operations further comprising:
cleaning the temperature data in the database for validity before splitting the database into the training dataset and the evaluation dataset.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
collecting temperature data corresponding to historical drilling operations of a well, and storing the collected temperature data in a database;
splitting the database into a training dataset and an evaluation dataset;
generating, using the training dataset, space-time-temperature probability models;
training, using the evaluation dataset, the space-time-temperature probability models;
evaluating the space-time-temperature probability models to ensure a performance level above a model accuracy threshold; and
generating, using the space-time-temperature probability models, a predicted temperature profile for a new well.

16. The computer-implemented system of claim 15, the operations further comprising:
generating, for display in a user interface, a plot of the predicted temperature profile for the new well

17. The computer-implemented system of claim 15, wherein the space-time-temperature probability models include a kriging spatial model, a time series forecasting model, and a probabilistic meta model.

18. The computer-implemented system of claim 15, the operations further comprising:
cleaning the temperature data for validity before splitting the database into the training dataset and the evaluation dataset.

19. The computer-implemented system of claim 15, the operations further comprising:
triggering, based on triggering criteria, re-training of the space-time-temperature probability models; and
re-training the space-time-temperature probability models over time.

20. The computer-implemented system of claim 19, wherein the triggering criteria includes one or more of a regular retraining schedule, an occurrence of collecting new oil/gas surveys, and changes in the model accuracy threshold.
